(19) United States
(12) Patent Application Publication
(10) Pub. No.: US 2021/0019819 A1
(43) Pub. Date: Jan. 21, 2021

(54) INFORMATION PROCESSING APPARATUS AND INFORMATION PROCESSING SYSTEM

(71) Applicant: KABUSHIKI KAISHA TOKAI RIKA DENKI SEISAKUSHO, Aichi (JP)

(72) Inventors: Masanori KOSUGI, Aichi (JP); Takashi NAGAO, Aichi (JP)

(73) Assignee: KABUSHIKI KAISHA TOKAI RIKA DENKI SEISAKUSHO, Aichi (JP)

(21) Appl. No.: 16/980,997

(22) PCT Filed: Feb. 6, 2019
(86) PCT No.: PCT/JP2019/004216

§ 371 Date: Sep. 15, 2020

(30) Foreign Application Priority Data
Apr. 17, 2018 (JP) 2018-079359

(51) Int. Cl. G06Q 30/06; G06Q 30/02; G06Q 10/02; G06Q 50/30

(52) U.S. Cl. CPC G06Q 30/0645; G06Q 30/0206; G06Q 2240/00; G06Q 50/30; G06Q 10/02

(57) ABSTRACT

[Object] To provide an information processing apparatus and information processing system that make it possible to get commissioned to control rental of a mobile object and dynamically set a free for controlling the rental of the mobile object.

[Solution] Provided is an information processing apparatus including: a rental control unit configured to perform a control process related to rental of a mobile object; a pricing unit configured to dynamically set a control fee for the control process on a basis of an index acquired on a basis of rental information regarding the rental of the mobile object; and a transmission control unit configured to cause transmission of control result information to a predetermined external apparatus, the control result information including one or both of a content of the performed control process and the set control fee.

### TECHNICAL FIELD

The present invention relates to an information processing apparatus and an information processing system.

### BACKGROUND ART

There has been developed a technology related to “a system that uses an apparatus that does not belong to a service provider to perform a process that has been performed by an apparatus that belongs to the service provider”. For example, a technology described in Patent Literature 1 listed below is exemplified as a technology related to “a taxi dispatching system that allows a cooperative taxi dispatching center (traffic management system) to conduct a taxi dispatching intermediate business with regard to taxis having a taxi dispatching intermediate contract, and collects a contract fee that has been decided in advance on the basis of the taxi dispatching intermediate contract”.

### CITATION LIST

### Patent Literature

Patent Literature 1: JP 2003-91796A

### DISCLOSURE OF INVENTION

### Technical Problem

In the taxi dispatching system described in Patent Literature 1 listed above, the cooperative taxi dispatching center conducts the taxi dispatching intermediate business on behalf of taxi companies (corresponding to service providers) and collects a contract fee that has been decided in advance on the basis of the taxi dispatching intermediate contract as a fee for the taxi dispatching intermediate business.

Here, the technology described in Patent Literature 1 merely considers collection of the contract fee that has been decided in advance as an agent fee for the taxi dispatching intermediate business. Therefore, even when using the technology described in Patent Literature 1 listed above, it is impossible to dynamically set a fee for being commissioned to perform a process that has been performed by an apparatus belonging to the service provider.

An object of the present invention is to provide a novel and improved information processing apparatus and information processing system that make it possible to get commissioned to control rental of a mobile object and dynamically set a free for controlling the rental of the mobile object.

### Solution to Problem

To achieve the above-described purpose, according to a first aspect of the present invention, there is provided an information processing apparatus including: a rental control unit configured to perform a control process related to rental of a mobile object; a pricing unit configured to dynamically set a control fee for the control process on a basis of an index acquired on a basis of rental information regarding the rental of the mobile object; and a transmission control unit configured to cause transmission of control result information to a predetermined external apparatus, the control result information including one or both of a content of the performed control process and the set control fee.

According to such a configuration, it is possible for the information processing apparatus to get commissioned to perform the control process and dynamically set the control fee. Therefore, according to such a configuration, it is possible to achieve the information processing system that delegates control of rental of the mobile object and dynamically sets the fee for controlling the rental of the mobile object.

In addition, the rental information may include information indicating a result of the rental of the mobile object, and the pricing unit may acquire the number of rentals of the mobile object as the index, and set the control fee depending on the number of rentals of the mobile object.

In addition, the rental information may include information indicating a result of the rental of the mobile object, and the pricing unit may acquire a rental status of the mobile object as the index, and set the control fee depending on the rental status.

In addition, the rental information may include information regarding reservation for rental of the mobile object, and the pricing unit may acquire a rental reservation status of the mobile object as the index, and set the control fee depending on the rental reservation status.

In addition, to achieve the above-described purpose, according to a second aspect of the present invention, there is provided an information processing system including: a first information processing apparatus; and a second information processing apparatus. The first information processing apparatus includes a rental control unit configured to perform a control process related to rental of a mobile object, a pricing unit configured to dynamically set a control fee for the control process on a basis of an index acquired on a basis of rental information regarding the rental of the mobile object, and a transmission control unit configured to cause transmission of control result information to the second information processing apparatus, the control result information including one or both of a content of the performed control process and the set control fee.

Such an information processing system commissions the first information processing apparatus to perform the control process and dynamically sets the control fee. Therefore, according to such a configuration, it is possible to achieve the information processing system that delegates control of rental of the mobile object and dynamically sets the fee for controlling the rental of the mobile object.

### Advantageous Effects of Invention

According to the present invention, it is possible to achieve the information processing system that gets commissioned to control rental of the mobile object and dynamically sets the fee for controlling the rental of the mobile object.

### BRIEF DESCRIPTION OF DRAWINGS

FIG. 1 is a block diagram illustrating an example of an information processing system according to an embodiment of the present invention.

FIG. 2 is a block diagram illustrating an example of a functional configuration of the information processing apparatus according to the embodiment of the present invention.

FIG. 3 is an explanatory diagram illustrating an example of a hardware configuration of the information processing apparatus according to the embodiment of the present invention.

### MODE(S) FOR CARRYING OUT THE INVENTION

Hereinafter, preferred embodiments of the present invention will be described in detail with reference to the appended drawings. Note that, in this specification and the appended drawings, structural elements that have substantially the same function and structure are denoted with the same reference signs, and repeated explanation of these structural elements will be omitted.

[1] Information Processing System According to Embodiment of Present Invention

In a conventional system that makes it possible to achieve a service related to a mobile object, all processes related to the service are performed by an apparatus belonging to a service provider that provides the service related to the mobile object.

On the other hand, an information processing system according to an embodiment of the present invention is “a system that allows an apparatus that does not belong to the service provider to perform at least a portion of the processes performed by the apparatus belonging to the service provider that provides the service related to the mobile object in the conventional system. In other words, the information processing system according to the embodiment of the present invention commissions an apparatus belonging to an entity or person different from the service provider to perform at least a portion of the processes performed by the apparatus belonging to the service provider.

Here, the apparatus belonging to an entity or person according to the embodiment of the present invention means an apparatus owned by the entity or person, or an apparatus that is managed by the entity or person directly or indirectly, for example. In addition, an apparatus that does not belong to an entity or person according to the embodiment of the present invention means an apparatus that is not owned by the entity or person, or an apparatus that is unmanageable for the entity or person directly or indirectly, for example.

Examples of the service related to the mobile object according to the embodiment of the present invention include a mobile object rental service such as a car-sharing service. Hereinafter, a service provider that provides a mobile object rental service will be referred to as a “mobile object service provider”. Examples of the mobile object service provider include a company that conducts a mobile object rental service business such as a car-sharing company. Note that, the examples of the mobile object service provider are obviously not limited to the above-described example.

Examples of the mobile object according to the embodiment of the present invention include any mobile objects that may serve as rental targets such as “a vehicle like a car, motorcycle, a bicycle, a ship, an airplane, or a ship”, or “an unmanned mobile object like an unmanned aerial vehicle called a drone”. Hereinafter, a case will be exemplified where the mobile object according to the embodiment of the present invention is a vehicle such as a car.

In the information processing system according to the embodiment of the present invention, “the apparatus belonging to an entity or person different from the mobile object service provider” performs a process related to control of rental of a mobile object (hereinafter, referred to as a “control process”) among processes for achieving the mobile object rental service. Hereinafter, the entity or person different from the mobile object service provider will be referred to as a “mobile object control operator”. Examples of the mobile object control operator include a company that conducts a mobile object rental control agency business such as a company commissioned by a car-sharing company to control rental of mobile objects. Note that, the examples of the mobile object control operator are obviously not limited to the above-described example.

The information processing system according to the embodiment of the present invention uses an apparatus belonging to the mobile object control operator to perform the control process (to be described later). Therefore, it is only necessary for the mobile object service provider to take care of operation of the mobile objects such as maintenance of the mobile objects.

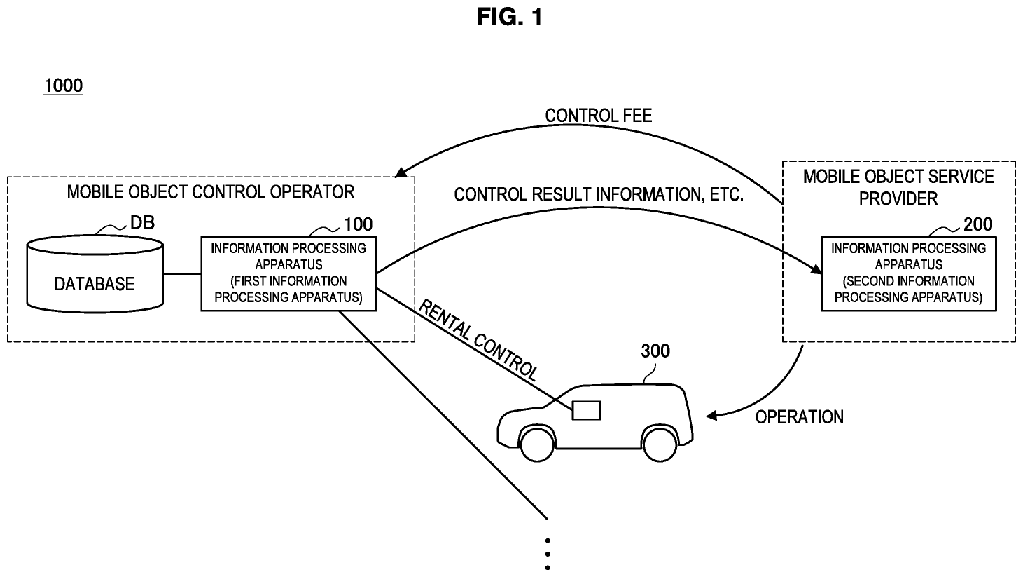

FIG. 1 is a block diagram illustrating an example of an information processing system 1000 according to the embodiment of the present invention. The information processing system 1000 is an example of a system that makes it possible to achieve a vehicle rental service.

For example, the information processing system 1000 includes an information processing apparatus 100 (first information processing apparatus) and an information processing apparatus 200 (second information processing apparatus). The information processing apparatus 100 is an example of the apparatus belonging to the mobile object control operator. The information processing apparatus 200 is an example of the apparatus belonging to the mobile object service provider.

FIG. 1 also illustrates a vehicle 300 (an example of the mobile object; the same applies hereinafter) serving as a rental target with regard to a rental service. As described above, the mobile object service provider may take care of operation of the vehicle 300 such as the maintenance.

Note that, the information processing system 1000 may or may not include the vehicle 300 serving as the rental target. In addition, the number of the vehicles 300 serving as the rental targets is not limited to the example illustrated in FIG. 1. The number of the vehicles 300 serving as the rental targets may be any numerical value of one or more.

In addition, FIG. 1 also illustrates a database DB that records rental information (to be described later). The database DB may be stored in a recording medium (to be described later) included in the information processing apparatus 100 or may be stored in a recording medium external to the information processing apparatus 100. The database DB may be stored in any recording medium that is readable by the information processing apparatus 100. Note that, the method of recording the rental information (to be described later) on the recording medium is not limited to the database format. It is also possible to record the rental information on the recording medium in any format.

[1-1] Information Processing Apparatus 100 (First Information Processing Apparatus)

The information processing apparatus 100 is the apparatus belonging to the mobile object control operator, and performs a control process related to control of rental of the mobile object (to be described later).

The control process (to be described later) corresponds to “a portion of the processes for achieving the mobile object rental service, the processes having been performed by the apparatus belonging to the mobile object service provider in the conventional system”. In other words, the information processing apparatus 100 achieves “the information processing system that commissions the apparatus belonging to the mobile object control operator different from the service provider to perform at least a portion of the processes performed by the apparatus belonging to the service provider”. That is, the information processing apparatus 100 achieves an information processing system that is different from the conventional systems.

In addition, in the case where the apparatus belonging to the mobile object control operator is commissioned to perform the control process (to be described later) that has been performed by the apparatus belonging to the mobile object service provider in the conventional system, the mobile object control operator is assumed to receive a fee for commission of the control process (to be described later) from the mobile object service provider. Hereinafter, the fee for commission of the control process, that is, the fee for the control process is referred to as a “control fee”.

As described above, the technology described in Patent Literature 1 listed above merely considers collection of the contract fee that has been decided in advance as an agent fee for the taxi dispatching intermediate business. Therefore, even when using the technology described in Patent Literature 1 in the above-described condition, the mobile object control operator can merely receive a predecided contract fee.

Accordingly, the information processing apparatus 100 further performs a setting process (to be described later) for dynamically setting the control fee. When the information processing apparatus 100 performs the setting process (to be described later), it is possible to dynamically set the control fee depending on a result of the performed control process.

This makes it possible for the mobile object control operator to receive, from the mobile object service provider, a control fee depending on a result of the performed control process, that is, a control fee that is more commensurate with the performed control process, for example.

Next, an example of the configuration of the information processing apparatus 100 will be described, and details of an example of the process performed by the information processing apparatus 100 will be described.

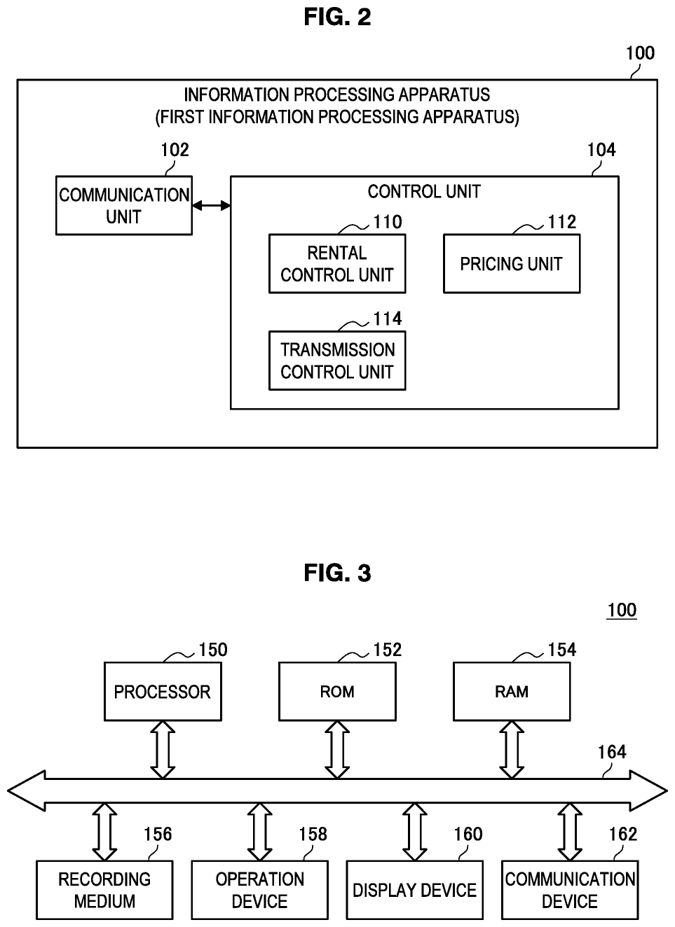

FIG. 2 is a block diagram illustrating an example of the functional configuration of the information processing apparatus 100 according to the embodiment of the present invention. The information processing apparatus 100 includes a communication unit 102 and a control unit 104, for example.

In addition, the information processing apparatus 100 may include a portion or all of a storage unit (not illustrated), an operation unit (not illustrated) that is operable by a user of the information processing apparatus 100, a display unit (not illustrated) that displays various kinds of screens on a display screen, and the like. In the information processing apparatus 100, the respective structural elements are connected via a bus serving as a data transmission channel, for example.

The information processing apparatus 100 is driven by electric power supplied from an internal power source such as a battery included in the information processing apparatus 100, or electric power supplied by an external power source such as a commercial electric power source, for example.

FIG. 3 is an explanatory diagram illustrating an example of a hardware configuration of the information processing apparatus 100 according to the embodiment of the present invention. The information processing apparatus 100 includes a processor 150, ROM 152, RAM 154, a recording medium 156, an operation device 158, a display device 160, and a communication device 162, for example. In addition, in the information processing apparatus 100, the structural elements are connected via a bus 164 serving as a data transmission channel, for example. The information processing apparatus 100 is driven by electric power supplied from an internal power source such as a battery included in the information processing apparatus 100, or electric power supplied by an external power source such as a commercial electric power source, for example.

The processor 150 includes one processor or two or more processors, for example. For example, the processor included in the processor 150 may be a central processing unit (CPU) or the like.

The processor 150 serves as, for example, the control unit 104, and controls the whole information processing apparatus 100. In addition, the processor 150 also serves as a rental control unit 110, a pricing unit 112, and a transmission control unit 114 (to be described later) in the information processing apparatus 100. Note that, it is also possible for a processor other than the processor 150 to serve as a portion or all of the rental control unit 110, the pricing unit 112, and the transmission control unit 114.

The ROM 152 stores programs to be used by the processor 150, control data such as arithmetic parameters, and the like. The RAM 154 temporarily stores programs and the like to be executed by the processor 150, for example.

The recording medium 156 functions as the storage unit (not illustrated). Examples of the recording medium 156 include any recording medium such as a magnetic recording medium or nonvolatile memory, for example. The recording medium 156 may be detachably attached to the information processing apparatus 100. For example, the recording medium 156 may store the database DB, a program (computer program; this will be described later) that causes a computer or the like to function as the information processing apparatus 100, and the like.

The operation device 158 functions as the operation unit (not illustrated). Examples of the operation device 158 include any operation device such as a button, arrow keys, or a combination thereof.

The display device 160 functions as the display unit (not illustrated). Examples of the display device 160 include any display device such as a liquid crystal display or an organic EL display. In addition, the display device 160 may be a device that achieves both display and user operation such as a touchscreen. For example, the processor 150 controls display on the display device 160.

The communication device 162 functions as the communication unit (not illustrated), and serves to communicate with an external apparatus such as the information processing apparatus 200 or the vehicle 300 in a wired or wireless manner.

Examples of the communication device 162 include communication devices that support any communication method such as a communication antenna and a radio frequency (RF) circuit (wireless communication), an IEEE 802.15.1 port and a transceiver circuit (wireless communication), an IEEE 802.11 port and a transceiver circuit (wireless communication), or a local area network (LAN) terminal and a transceiver circuit (wired communication). The communication performed by the communication unit (not illustrated) is controlled by the processor 150, for example.

The information processing apparatus 100 has the hardware configuration as illustrated in FIG. 3, for example. Note that, the hardware configuration of the information processing apparatus 100 according to the embodiment of the present invention is not limited to the configuration in FIG. 3.

For example, in the case where the information processing apparatus 100 communicates with the external apparatus such as the information processing apparatus 200 or the vehicle 300 via a connected external communication device, the information processing apparatus 100 does not have to include the communication device 162. In addition, the communication device 162 may be configured to be capable of communication with one or more external devices through a plurality of communication methods.

In addition, in the information processing apparatus 100, the processor 150 may include one or both of the ROM and the RAM. In this case, the information processing apparatus 100 may be configured in such a manner that one or both of the ROM 152 and the RAM 154 is omitted.

In addition, the information processing apparatus 100 may be configured in such a manner that a portion or all of the recording medium 156, the operation device 158, and the display device 160 is omitted.

In addition, for example, the information processing apparatus 100 may be configured in accordance with application examples of the information processing apparatus 100 (to be described later).

In addition, for example, a portion or all of the structural elements illustrated in FIG. 3 (or structural elements according to a modified embodiment) may be implemented as one or more integrated circuits (ICs).

With reference to FIG. 2 again, the example of the functional configuration of the information processing apparatus 100 will be described.

The communication unit 102 communicates with the external apparatus such as the information processing apparatus 200 or the vehicle 300 in a wired or wireless manner, for example. Examples of the communication unit 102 include the communication device 162 (to be described later)

For example, the control unit 104 is implemented as the processor 150 and serves to control the whole information processing apparatus 100.

In addition, for example, the control unit 104 includes the rental control unit 110, the pricing unit 112, and the transmission control unit 114. This makes it possible to commission the control unit 104 to perform the control process (to be described later) and dynamically set the control fee.

[1-1-1] Rental Control Unit 110

The rental control unit 110 performs a control process related to rental of a mobile object.

The control process according to the embodiment of the present invention is a process related to control of rental of the mobile object among processes for achieving the mobile object rental service. Examples of the control process include processes related to operation of the service related to rental of the mobile object such as a process related to reservation of the vehicle 300, a process related to control of rental of the vehicle 300, and a process of recording rental information on the recording medium.

Examples of the process related to reservation of the vehicle 300 include a process of managing a reservation status of each vehicle 300 serving as a control target. Examples of the reservation status of the vehicle 300 include a state where reservation for rental of the vehicle 300 is made, a state where reservation is canceled, and a state where reservation for rental of the vehicle 300 is not made. The information processing apparatus 100 updates a database (or table) for managing reservation statuses of the vehicles 300 on the basis of a request from a user of the rental service of the vehicles 300 (hereinafter, simply referred to as a “user”). This makes it possible to manage the reservation statuses of the vehicles 300. The database for managing the reservation statuses is stored in the recording medium such as the recording medium 156, for example.

Note that, the examples of the process related to reservation of the vehicle 300 are obviously not limited to the above-described example.

Examples of the process related to control of rental of the vehicle 300 include “a process of transmitting key information (so-called one-time password) that is valid for only a predetermined period of time to a predetermined apparatus associated with a user who has reserved the vehicle 300”. Examples of the predetermined apparatus associated with the user include a portable apparatus such as a smartphone or a tablet device, for example. Note that, the predetermined apparatus associated with the user is obviously not limited to the above-described example.

The key information transmitted to the predetermined apparatus is a key that is temporarily valid for authentication to be performed by the reserved vehicle 300 or an authentication apparatus installed in the vehicle 300, for example. Examples of the key information include data corresponding to any method that makes it possible to configure the one-time password such as data indicating a key that supports challenge-response authentication.

Note that, for example, the information processing apparatus 100, an operator of the vehicle 300 such as the mobile object service provider, a manufacturer of the vehicle 300, or the like may record various kinds of data on the recording medium installed in the vehicle 300 or the authentication apparatus. The various kinds of data is to be used by the vehicle 300 or the authentication apparatus for the authentication process using the key information. In the case where the information processing apparatus 100 records the various kinds of data to be used for the authentication process using the key information on the recording medium installed in the vehicle 300 or the authentication apparatus, the various kinds of data is recorded on the recording medium as a part of the process related to control of rental, for example.

The authentication using the key information is performed between the vehicle 300 and the predetermined apparatus that has received the key information. When the authentication is completed normally, the vehicle 300 enters a normal operation state. As a result, it becomes possible for the user to use the vehicle 300.

Note that, the examples of the process related to control of rental according to the embodiment of the present invention are obviously not limited to the above-described example.

Examples of the process of recording the rental information on the recording medium include “a process of recording the rental information on the database DB stored in any recording medium such as the recording medium 156”.

The rental information according to the embodiment of the present invention is data related to rental of the mobile object. The rental information indicates contents of the performed control process. Examples of the rental information include one or both of information indicating a result of rental of the mobile object and information regarding reservation for rental of the mobile object. The rental information may include a database for managing the reservation statuses.

Examples of the information indicating the result of rental of the mobile object according to the embodiment of the present invention include rental log data. For example, the information indicating the result of rental of the mobile object indicate when, where (or which area), how long, and which user has rented which vehicle 300. Note that, the contents indicated by the information indicating the result of rental of the mobile object are not limited to the above-described example. For example, the information indicating the result of rental of the mobile object may include various kinds of contents related to the mobile objects such as a portion or all of a reservation period (reserved rental period) of a mobile object, an area where the mobile object is deployed, and equipment installed in the mobile object, for example.

Examples of the information regarding reservation for rental of the mobile object according to the embodiment of the present invention include data indicating contents of the reservation and data indicating contents of cancellation of reservation. For example, as the data indicating contents of the reservation, information indicating when, how long, and which user has reserved which vehicle 300 is recorded in association with an ID for identifying the contents of reservation. In addition, as the data indicating the contents of cancellation of reservation, information indicating when and which user has canceled a reservation related to which reservation ID is recorded. Note that, the contents indicated by the information regarding reservation for rental of the mobile object is obviously not limited to the above-described example.

[1-1-2] Pricing Unit 112

The pricing unit 112 serve to perform the setting process and dynamically set a control fee for the control process.

The pricing unit 112 dynamically sets a control fee on the basis of an index acquired on the basis of the rental information. For example, the index acquired on the basis of the rental information indicates the number of rentals of the mobile object, a rental status of the mobile object, and a rental reservation status of the mobile object.

For example, the pricing unit 112 acquires the index on the basis of the rental information stored in any recording medium such as the recording medium 156. For example, the pricing unit 112 acquires the index by analyzing the rental information recorded on the database DB stored in the recording medium.

Note that, an external apparatus that is external to the information processing apparatus 100 may perform the process of analyzing the rental information. In the case where the external apparatus performs the process of analyzing the rental information, the pricing unit 112 acquires the index obtained as a result of the analysis performed by the external apparatus, from the external apparatus through communication via the communication unit 102, for example.

For example, the pricing unit 112 dynamically sets the control fee by performing a setting process according to a first example described in (A) listed below, a setting process according to a second example described in (B) listed below, or a setting process according to an third example described in (C) listed below. Note that, the examples of the index acquired on the basis of the rental information and the examples of the setting process performed by the pricing unit 112 are obviously not limited to the examples to be described below.

Hereinafter, specific examples of the setting processes will be described on the assumption that the mobile object is the vehicle 300.

(A) First Example of Setting Process: Example of Setting Process Using Number of Rentals of Mobile Object as Index

For example, the pricing unit 112 acquires the number of rentals of the vehicle 300 as an index by analyzing the rental information recorded on the database DB. As an example, the pricing unit 112 acquires the number of rentals of the vehicle 300 by analyzing information indicating results of rental of the mobile object (an example of the rental information). The number of rentals of the vehicle 300 may be the number of rentals of each of the vehicles 300, or may be the number of rentals of the plurality of vehicles 300 serving as the control targets. Examples of the plurality of vehicles 300 serving as the control targets include “all the vehicles 300 serving as the control targets” and “a portion of the vehicles 300 serving as the control targets such as vehicles 300 deployed in a predetermined area”.

Note that, it is also possible for the pricing unit 112 to acquire the number of rentals of the vehicles 300 from the external apparatus that is external to the information processing apparatus 100.

When the number of rentals of the vehicle 300 is acquired, the pricing unit 112 sets a control fee depending on the number of rentals of the vehicle 300.

For example, the pricing unit 112 set a lower control fee “in the case where the number of rentals of the mobile object is larger than a set threshold of the number of rentals” or “in the case where the number of rentals of the mobile object is more than or equal to the threshold of the number of rentals”.

In the case where there is only one threshold of the number of the rentals, the pricing unit 112 sets a control fee that is less than a standard fee by a predetermined amount, for example.

Alternatively, in the case where there are a plurality of thresholds of the number of rentals, it is possible for the pricing unit 112 to set a control fee that gradually decreases depending on the number of rentals of the vehicle 300 by comparing the number of rentals of the mobile object with the plurality of thresholds.

The thresholds of the number of rentals may be fixed values that have been set in advance, or may be variable values that can be changed in response to operation performed on the operation device 158 or the like.

For example, the pricing unit 112 that performs the setting process according to the first example dynamically sets the control fee by setting a lower control fees depending on the number of rentals of the vehicle 300 as described above.

The case of setting the lower control fee depending on the number of rentals of the vehicle 300 corresponds to the case where the number of rentals of the vehicle 300 is large. Here, in the case where the lower control fee is set depending on the number of rentals of the vehicle 300, the mobile object control operator has a greater opportunity to receive the control fee. Therefore, profits for the mobile object control operator are increased. Accordingly, the mobile object control operator can offer a so-called value discount.

In addition, since the lower control fee is set depending on the number of rentals of the vehicle 300, the mobile object service provider pays a lower control fee to the mobile object control operator than a fixed control fee. This allows the mobile object service provider to use, as resources, an amount of money saved by the decrease in the control fee to improve quality of the service related to the mobile objects or to decrease a usage fee to be paid by users.

Therefore, in the case where the information processing apparatus 100 performs the setting process according to the first example, it is possible to achieve an effect of “allowing both the mobile object control operator and the mobile object service provider to easily get profits”, for example.

Note that, the setting process according to the first example is not limited to the above-described example.

For example, the pricing unit 112 may dynamically set the control fee depending on the number of rentals related to each user.

(B) Second Example of Setting Process: Example of Setting Process Using Rental Status of Mobile Object as Index

For example, the pricing unit 112 acquires a rental status of the vehicle 300 as an index by analyzing the rental information recorded on the database DB. As an example, the pricing unit 112 acquires the rental status of the vehicle 300 by analyzing information indicating results of rental of the mobile object (an example of the rental information). Note that, it is also possible for the pricing unit 112 to acquire the rental status of the vehicle 300 from the external apparatus that is external to the information processing apparatus 100.

When the rental status of the vehicles 300 is acquired, the pricing unit 112 sets a control fee depending on the rental status of the vehicle 300. Next, examples of a setting process of setting a control fee depending on a rental status of the vehicle 300 will be described with reference to specific examples of the rental status of the vehicle 300.

(B-1) First Example of Rental Status of Vehicle 300

The first example of the rental status of the vehicle 300 according to the embodiment of the present invention includes “a rate of compliance with a rental period of each vehicle 300”, “a rate of compliance with a rental period in each predetermined area”, and “a rate of compliance with a rental period of each piece of equipment installed in a vehicle 300”, for example. The compliance with the rental period of the vehicle 300 means that “an actual rental period of the vehicle 300 falls within a reserved period of the vehicle 300”, for example.

In the case where the rental status of the vehicle 300 is represented as the rate of compliance with the rental period as described above, the pricing unit 112 sets the control fee depending on the rate of compliance with the rental period.

Specifically, the pricing unit 112 sets a higher control fee “in the case where the rate of compliance with the rental period is higher than a set threshold of the rate of compliance” or “in the case where the rate of compliance with the rental period is more than or equal to the threshold of the rate of compliance”.

In the case where there is only one threshold of the rate of compliance, the pricing unit 112 sets a control fee that is higher than a standard fee by a predetermined amount, for example.

Alternatively, in the case where there are a plurality of thresholds of the rate of compliance, it is possible for the pricing unit 112 to set a control fee that gradually increases depending on the rate of compliance with the rental period by comparing the rate of compliance with the rental period with the plurality of thresholds.

The thresholds of the rate of compliance may be fixed values that have been set in advance, or may be variable values that can be changed in response to operation performed on the operation device 158 or the like.

For example, the pricing unit 112 that performs the setting process according to the second example dynamically sets the control fee by setting a higher control fee depending on the rate of compliance with the rental period as described above.

Since the higher control fee is set depending on the rate of compliance with the rental period, the mobile object control operator receives a higher control fee from the mobile object service provider than a fixed control fee. This makes it possible to achieve an effect of “allowing the mobile object control operator to easily get profits”, for example.

Here, the case of setting the higher control fee depending on the rate of compliance with the rental period corresponds to the case where rental of the vehicles 300 is efficient and a profit per vehicle 300 is large. Therefore, the profits for the mobile object service provider are less affected even when the information processing apparatus 100 sets a higher control fee depending on a rate of compliance with a rental period.

(B-2) Second Example of Rental Status of Vehicle 300

The second example of the rental status of the vehicle 300 according to the embodiment of the present invention includes “a rate of rental periods shorter than reserved periods with regard to each vehicle 300”, “a rate of rental periods shorter than reserved periods with regard to each predetermined area”, and “a rate of rental periods shorter than reserved periods with regard to each piece of equipment installed in a vehicle 300”, for example.

In the case where the rental status of the vehicle 300 is represented as the rate of rental periods shorter than reserved periods as described above, the pricing unit 112 sets a control fee depending on the rate of rental periods shorter than reserved periods.

Specifically, the pricing unit 112 sets a higher control fee “in the case where the rate of rental periods shorter than reserved periods is higher than a set threshold of the rate of rental periods shorter than reserved periods” or “in the case where the rate of rental periods shorter than reserved periods is more than or equal to the threshold of the rate of rental periods shorter than reserved periods”.

In the case where there is only one threshold of the rate of rental periods shorter than reserved periods, the pricing unit 112 sets a control fee that is higher than a standard fee by a predetermined amount, for example.

Alternatively, in the case where there are a plurality of thresholds of the rate of rental periods shorter than reserved periods, it is possible for the pricing unit 112 to set a control fee that gradually increases depending on the rate of rental periods shorter than reserved periods by comparing the rate of rental periods shorter than reserved periods with the plurality of thresholds.

The thresholds of the rate of rental periods shorter than reserved periods may be fixed values that have been set in advance, or may be variable values that can be changed in response to operation performed on the operation device 158 or the like.

For example, the pricing unit 112 that performs the setting process according to the second example dynamically sets the control fee by setting a higher control fee depending on the rate of rental periods shorter than reserved periods as described above.

Since the higher control fee is set depending on the rate of rental periods shorter than reserved periods, the mobile object control operator receives a higher control fee from the mobile object service provider than a fixed control fee. This makes it possible to achieve an effect of “allowing the mobile object control operator to easily get profits”, for example.

Here, the case of setting the higher control fee depending on the rate of rental periods shorter than reserved periods corresponds to the case where rental of the vehicles 300 is efficient and a profit per vehicle 300 is large. Therefore, the profits for the mobile object service provider are less affected even when the information processing apparatus 100 sets a higher control fee depending on the rate of rental periods shorter than reserved periods.

(B-3) Third Example of Rental Status of Vehicle 300

The Third example of the rental status of the vehicle 300 according to the embodiment of the present invention includes “length of a rental period of single rental of each vehicle 300”, “length of a rental period of single rental in each predetermined area”, and “length of a rental period of single rental of each piece of equipment installed in a vehicle 300”, for example.

In the case where the rental status of the vehicle 300 is represented as the length of a rental period as described above, the pricing unit 112 sets a control fee depending on the length of the rental period.

Specifically, the pricing unit 112 sets a higher control fee “in the case where the length of a rental period is longer than a set threshold of the length of the rental period” or “in the case where the length of the rental period is more than or equal to the threshold of the length of the rental period”.

In the case where there is only one threshold of the length of the rental period, the pricing unit 112 sets a control fee that is higher than a standard fee by a predetermined amount, for example.

Alternatively, in the case where there are a plurality of thresholds of the length of the rental period, it is possible for the pricing unit 112 to set a control fee that gradually increases depending on the length of the rental period by comparing the length of the rental period with the plurality of thresholds.

The thresholds of the length of the rental period may be fixed values that have been set in advance, or may be variable values that can be changed in response to operation performed on the operation device 158 or the like.

For example, the pricing unit 112 that performs the setting process according to the second example dynamically sets the control fee by setting a higher control fee depending on the length of the rental period as described above.

Since the higher control fee is set depending on the length of the rental period, the mobile object control operator receives a higher control fee from the mobile object service provider than a fixed control fee. This makes it possible to achieve an effect of “allowing the mobile object control operator to easily get profits”, for example.

Here, the case of setting the higher control fee depending on the length of the rental period corresponds to the case where rental of the vehicles 300 is efficient and a profit per vehicle 300 is large. Therefore, the profits for the mobile object service provider are less affected even when the information processing apparatus 100 sets the higher control fee depending on the length of the rental period.

As described in the above examples (B-1) to (B-3), the pricing unit 112 sets the higher control fee as a control fee depending on a rental status of a vehicle 300 in the case where the rental status of the vehicle 300 indicates high efficiency of rental of the vehicle 300.

Note that, the setting process according to the second example is not limited to the above-described examples.

For example, the pricing unit 112 may set a lower control fee as a control fee depending on a rental status of a vehicle 300 in the case where the rental status of the vehicle 300 indicates low efficiency of rental of the vehicle 300. For example, in ways similar to the above examples (B-1) to (B-3), it is possible to determine that efficiency of rental of the vehicle 300 is low through a threshold process regarding each index.

In addition, for example, the pricing unit 112 may dynamically set the control fee depending on a rental status related to each user.

(C) Third Example of Setting Process: Example of Setting Process Using Rental Reservation Status of Mobile Object as Index

For example, the pricing unit 112 acquires a rental reservation status of the vehicle 300 as an index by analyzing the rental information recorded on the database DB. As an example, the pricing unit 112 acquires the rental reservation status of the vehicle 300 by analyzing information regarding reservation for rental of the mobile object (another example of rental information). Note that, it is also possible for the pricing unit 112 to acquire the rental reservation status of the vehicle 300 from the external apparatus that is external to the information processing apparatus 100.

When the rental reservation status of the vehicles 300 is acquired, the pricing unit 112 sets a control fee depending on the rental reservation status of the vehicle 300. Next, examples of a setting process of setting a control fee depending on a rental reservation status of the vehicle 300 will be described with reference to specific examples of the rental reservation status of the vehicle 300.

(C-1) First Example of Rental Reservation Status of Vehicle 300

A first example of the rental reservation status of the vehicle 300 according to the embodiment of the present invention includes “the number of reservations of each vehicle 300 within a predetermined period of time, “the number of reservations in each predetermined area within a predetermined period of time”, and “the number of reservations of each piece of equipment installed in a vehicle 300 within a predetermined period of time”, for example. The predetermined period may be a fixed period that has been set in advance, or may be a variable period that can be changed in response to operation performed on the operation device 158 or the like.

In the case where the rental reservation status of the vehicle 300 is represented as the number of reservations as described above, the pricing unit 112 sets a control fee depending on the number of reservations.

Specifically, the pricing unit 112 sets a higher control fee “in the case where the number of reservations is larger than a set threshold of the number of reservations” or “in the case where the number of reservations is more than or equal to the threshold of the number of reservations”.

In the case where there is only one threshold of the number of reservations, the pricing unit 112 sets a control fee that is higher than a standard fee by a predetermined amount, for example.

Alternatively, in the case where there are a plurality of thresholds of the number of reservations, it is possible for the pricing unit 112 to set a control fee that gradually increases depending on the number of reservations by comparing the number of reservations with the plurality of thresholds.

The thresholds of the number of reservations may be fixed values that have been set in advance, or may be variable values that can be changed in response to operation performed on the operation device 158 or the like.

For example, the pricing unit 112 that performs the setting process according to the third example dynamically sets the control fee by setting the higher control fee depending on the number of reservations as described above.

Since the higher control fee is set depending on the number of reservations, the mobile object control operator receives a higher control fee from the mobile object service provider than a fixed control fee. This makes it possible to achieve an effect of “allowing the mobile object control operator to easily get profits”, for example.

Here, the case of setting the higher control fee depending on the number of reservations corresponds to the case where rental of the vehicles 300 is efficient and a profit per vehicle 300 is large. Therefore, the profits for the mobile object service provider are less affected even when the information processing apparatus 100 sets the higher control fee depending on the number of reservations.

(C-2) Second Example of Rental Reservation Status of Vehicle 300

A second example of the rental reservation status of the vehicle 300 according to the embodiment of the present invention includes “the number of cancellations of reservations of each vehicle 300 within a predetermined period of time, “the number of cancellations of reservations in each predetermined area within a predetermined period of time”, and “the number of cancellations of reservations of each piece of equipment installed in a vehicle 300 within a predetermined period of time”, for example.

In the case where the rental reservation status of the vehicle 300 is represented as the number of cancellations of reservations as described above, the pricing unit 112 sets a control fee depending on the number of cancellations of reservations.

Specifically, the pricing unit 112 sets a higher control fee “in the case where the number of cancellations of reservations is smaller than a set threshold of the number of cancellations of reservations” or “in the case where the number of cancellations of reservations is less than or equal to the threshold of the number of cancellations of reservations”.

In the case where there is only one threshold of the number of cancellations of reservations, the pricing unit 112 sets a control fee that is higher than a standard fee by a predetermined amount, for example.

Alternatively, in the case where there are a plurality of thresholds of the number of cancellations of reservations, it is possible for the pricing unit 112 to set a control fee that gradually increases depending on the number of cancellations of reservations by comparing the number of cancellations of reservations with the plurality of thresholds.

The thresholds of the number of cancellations of reservations may be fixed values that have been set in advance, or may be variable values that can be changed in response to operation performed on the operation device 158 or the like.

For example, the pricing unit 112 that performs the setting process according to the third example dynamically sets the control fee by setting the higher control fee depending on the number of cancellations of reservations as described above.

Since the higher control fee is set depending on the number of cancellations of reservations, the mobile object control operator receives a higher control fee from the mobile object service provider than a fixed control fee. This makes it possible to achieve an effect of “allowing the mobile object control operator to easily get profits”, for example.

Here, the case of setting the higher control fee depending on the number of cancellations of reservations corresponds to the case where rental of the vehicles 300 is efficient and a profit per vehicle 300 is large. Therefore, the profits for the mobile object service provider are less affected even when the information processing apparatus 100 sets the higher control fee depending on the number of cancellations of reservations.

For example, as described in the above examples (C-1) and (C-2), the pricing unit 112 sets the higher control fee as a control fee depending on a reservation status of a vehicle 300 in the case where the reservation status of the vehicle 300 indicates high efficiency of rental of the vehicle 300.

Note that, the setting process according to the third example is not limited to the above-described examples.

For example, the pricing unit 112 may set a lower control fee as a control fee depending on a reservation status of a vehicle 300 in the case where the reservation status of the vehicle 300 indicates low efficiency of rental of the vehicle 300. For example, in ways similar to the above examples (C-1) and (C-2), it is possible to determine that efficiency of rental of the vehicle 300 is low through a threshold process regarding each index.

In addition, for example, the pricing unit 112 may dynamically set the control fee depending on a reservation status related to each user.

[1-1-3] Transmission Control Unit 114

For example, the transmission control unit 114 serves to control communication to be performed by a communication device constituting the communication unit 102 or communication to be performed by an external communication device connected to the information processing apparatus 100. For example, the transmission control unit 114 controls communication to be performed by the communication device serving as a control target by sending a control signal for controlling the communication device and transmission target data to the communication device serving as the control target.

As an example, the transmission control unit 114 causes transmission of control result information to a predetermined external apparatus.

For example, the control result information according to the embodiment of the present invention is data including one or both of a result of a process performed by the rental control unit 110 and a result of a process performed by the pricing unit 112. Examples of the data indicating the result of the process performed by the rental control unit 110 include the rental information. In addition, examples of the data indicating the result of the process performed by the pricing unit 112 include data indicating the control fee. In other words, for example, the control result information includes one or both of contents of the control process performed by the rental control unit 110 and the control fee set by the pricing unit 112.

In addition, examples of the predetermined external apparatus according to the embodiment of the present invention include an apparatus belonging to the mobile object service provider such as the information processing apparatus 200. Note that, the predetermined external apparatus may be an apparatus other than the apparatus belonging to the mobile object service provider, such as a relay apparatus that relays transmission of the control result information to the apparatus belonging to the mobile object service provider.

When the control result information is transmitted to the apparatus belonging to the mobile object service provider such as the information processing apparatus 200, it is possible for the mobile object service provider to recognize the contents of the control process performed by the mobile object control operator and the set control fee. Accordingly, in the information processing system 1000, it is possible for the mobile object service provider to smoothly pay the control fee to the mobile object control operator as illustrated in FIG. 1, for example.

Note that, the example of information transmitted by the transmission control unit 114 to the predetermined external apparatus is not limited to the control result information.

For example, the transmission control unit 114 may further cause transmission of information indicating a result of analysis of rental information to the predetermined external apparatus. As described above, the information processing apparatus 100 or the external apparatus that is external to the information processing apparatus 100 may perform a process of analyzing the rental information.

Examples of the information indicating the result of analysis of the rental information include data that notifies of a condition for high profitability such as data indicating an ID of a vehicle 300 with high profitability, data indicating an ID of an area with high profitability, and data indicating a piece of equipment with high profitability. In addition, other examples of the information indicating the result of analysis of the rental information include data that notifies of a condition for low profitability such as data indicating an ID of a vehicle 300 with low profitability, data indicating an ID of an area with low profitability, and data indicating a piece of equipment with low profitability. Note that, the example of information indicating a result of analysis of rental information is obviously not limited to the above-described examples.

For example, when the above-exemplified information indicating a result of analysis of rental information is transmitted to the apparatus belonging to the mobile object service provider such as the information processing apparatus 200, the mobile object service provider can get higher profits by improving or enhancing the profitability. In addition, if it is possible to get higher profits by using the information indicating a result of analysis of rental information, the mobile object service provider is considered to be easily accept a result of setting a control fee even when the information processing apparatus 100 sets a higher control fee.

Therefore, when the above-exemplified information indicating a result of analysis of rental information is transmitted to the apparatus belonging to the mobile object service provider such as the information processing apparatus 200, it is possible to achieve the effect of “allowing both the mobile object control operator and the mobile object service provider to easily get profits”, for example.

For example, the control unit 104 includes the rental control unit 110, the pricing unit 112, and the transmission control unit 114. This makes it possible to commission the control unit 104 to perform the control process and dynamically set the control fee.

Note that, the functional configuration of the control unit 104 is not limited to the example illustrated in FIG. 2. For example, the control unit 104 may have any functional configuration depending on how to divide up the functions of the information processing apparatus 100.

For example, the information processing apparatus 100 is commissioned to perform the control process and dynamically set the control fee through the functional configuration illustrated in FIG. 2.

Note that, the functional configuration of the information processing apparatus 100 is not limited to the example illustrated in FIG. 2.

For example, the information processing apparatus 100 may include a portion or all of the rental control unit 110, the pricing unit 112, and the transmission control unit 114 illustrated in FIG. 2 separately from the control unit 104 (for example, they are implemented as different processing circuits).

In addition, in the case where communication is established with the external apparatus via an external communication device having a similar function and configuration to the communication unit 102, the information processing apparatus 100 does not have to include the communication unit 102, for example.

[1-2] Information Processing Apparatus 200 (Second Information Processing Apparatus)

The information processing apparatus 200 is the apparatus belonging to the mobile object service provider. For example, the information processing apparatus 200 performs any process related to the service related to the mobile object other than the processes delegated to the mobile object control operator. Note that, it is also obviously possible for the information processing apparatus 200 to perform the processes delegated to the mobile object control operator.

The information processing apparatus 200 has a similar hardware configuration to the information processing apparatus 100 described with reference to FIG. 3, for example. The information processing apparatus 200 is driven by electric power supplied from an internal power source such as a battery included in the information processing apparatus 200, or electric power supplied by an external power source such as a commercial electric power source.

[2] Example of Effect Achieved by Information Processing System according to Embodiment of Present Invention

For example, the following effects are achieved when using the information processing system according to the embodiment of the present invention such as the information processing system 1000 illustrated in FIG. 1, for example. Note that, the effects achieved by the information processing system according to the embodiment of the present invention are obviously not limited to the following effects.

In the information processing system according to the embodiment of the present invention, the information processing apparatus 100 (first information processing apparatus) belonging to the mobile object control operator is commissioned to perform the control process, and the control fee is dynamically set on the basis of the index based on the rental information. Since the control fee is dynamically set as described above, it is possible to achieve an effect of “allowing both the mobile object control operator and the mobile object service provider to easily get profits”, for example.

[3] Application Examples of Respective Apparatuses Included in Information Processing System according to Embodiment of Present Invention

The information processing apparatus 100 (first information processing apparatus) has been described as a structural element of the information processing system according to the embodiment of the present invention. However, the embodiment of the present invention is not limited thereto. The embodiment of the present invention is applicable to various kinds of equipment capable of performing the processes performed by the above-described information processing apparatus 100, such as “a computer like a personal computer (PC) or a server” or “a tablet device”, for example. In addition, the embodiment of the present invention may also be applicable to a processing IC which can be installed in the above described equipment, for example.

In addition, the information processing apparatus 200 (second information processing apparatus) has been described as a structural element of the information processing system according to the embodiment of the present invention. However, the embodiment of the present invention is not limited thereto. The embodiment of the present invention is applicable to various kinds of equipment capable of performing the processes performed by the above-described information processing apparatus 200, such as “a computer like a PC or a server” or “a tablet device”, for example. In addition, the embodiment of the present invention may also be applicable to a processing IC which can be installed in the above described equipment, for example.

[4] Program According to Embodiment of Present Invention

A program for causing a computer to function as the first information processing apparatus according to the embodiment of the present invention (for example, program for causing the computer to function as the rental control unit 110, the pricing unit 112, and the transmission control unit 114 illustrated in FIG. 2) is executed by a processor or the like in the computer. Thereby, it is possible to achieve the information processing system that delegates control of rental of the mobile objects and dynamically sets a fee for controlling rental of the mobile objects.

In addition, it is also possible to obtain the above-described effects achieved by the above-described information processing system according to the embodiment of the present invention by allowing the program for causing the computer to function as the first information processing apparatus according to the embodiment of the present invention to be executed by a processor in the computer.

Hereinabove, although the preferred embodiments of the present invention have been described with reference to the accompanying drawings, the present invention is obviously not limited thereto. It will be clear to a person of ordinary skill in the art of the present invention that various modifications and improvements may be obtained within the scope of the technological concept recited by the scope of the patent claims, and these should obviously be understood as belonging to the range of technology of the present invention.

For example, the program (computer program) for causing the computer to function as the first information processing apparatus according to the embodiment of the present invention has been provided above. However, the embodiment of the present invention can also provide a recording medium in which the foregoing program is stored. Examples of the recording medium in which the foregoing program is stored include “a recording medium included in an apparatus that functions as the first information processing apparatus according to the embodiment of the present invention such as the recording medium 156 illustrated in FIG. 3” and “an external recording medium that is external to the apparatus and that stores the program, which is readable by the apparatus functioning as the first information processing apparatus according to the embodiment of the present invention”.

### REFERENCE SIGNS LIST

100, 200 information processing apparatus
102 communication unit
104 control unit
110 rental control unit
112 pricing unit
114 transmission control unit
300 vehicle
1000 information processing system

1. An information processing apparatus comprising:
a rental control unit configured to perform a control process related to rental of a mobile object;
a pricing unit configured to dynamically set a control fee for the control process on a basis of an index acquired on a basis of rental information regarding the rental of the mobile object; and
a transmission control unit configured to cause transmission of control result information to a predetermined external apparatus, the control result information including one or both of a content of the performed control process and the set control fee.

2. The information processing apparatus according to claim 1, wherein
the rental information includes information indicating a result of the rental of the mobile object, and
the pricing unit
acquires the number of rentals of the mobile object as the index, and
sets the control fee depending on the number of rentals of the mobile object.

3. The information processing apparatus according to claim 1, wherein
the rental information includes information indicating a result of the rental of the mobile object, and
the pricing unit
acquires a rental status of the mobile object as the index, and
sets the control fee depending on the rental status.

4. The information processing apparatus according to claim 1, wherein
the rental information includes information regarding reservation for rental of the mobile object, and
the pricing unit
acquires a rental reservation status of the mobile object as the index, and
sets the control fee depending on the rental reservation status.

5. An information processing system comprising:
a first information processing apparatus; and
a second information processing apparatus,
wherein the first information processing apparatus includes
a rental control unit configured to perform a control process related to rental of a mobile object,
a pricing unit configured to dynamically set a control fee for the control process on a basis of an index acquired on a basis of rental information regarding the rental of the mobile object, and
a transmission control unit configured to cause transmission of control result information to the second information processing apparatus, the control result information including one or both of a content of the performed control process and the set control fee.
